(19) United States
(12) Patent Application Publication
(10) Pub. No.: US 2006/0141925 A1
(43) Pub. Date: Jun. 29, 2006

(54) Hands-free adaptor

(76) Inventor: Avtar Singh Chagger, Coventry (GB)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/531,409

(22) PCT Filed: Oct. 14, 2003
(86) PCT No.: PCT/GB03/04489

§ 371 Date: Apr. 14, 2005

(30) Foreign Application Priority Data
Oct. 14, 2002 (GB) 0223808.7

(51) Int. Cl. H04H 7/00

(52) U.S. Cl. 455/3.06; 455/41.2

(57) ABSTRACT

An apparatus (100) suitable for connecting a communications device or other audio/audio-visual device to an audio system comprises a cassette-type audio adaptor (102) having receiver means for receiving audio and/or data signals transmitted from the device or the like and connecting means (120) connecting the receiver means to a head (118) of the cassette-type audio adaptor thereby to apply the signals to the head. The receiver means comprises at least a part of a Bluetooth chipset (104) disposed within C the cassette-type adaptor. The Bluetooth chipset (104) includes transmission means for transmitting audio signals back to the device as electromagnetic signals, and a microphone (114) is connected to the transmission means for detecting audio signals from a user and applying them to the transmission means.

The present invention relates to an adaptor and particularly, but not exclusively, to an adaptor which can be used as a simple, effective and inexpensive “hands-free kit” for a mobile phone or other communication device. The invention may also be used in connection with other electronic audio or audio-visual electronic devices.

With the recent proliferation of mobile phones and other such personal communication devices, the market for accessories for such devices has correspondingly increased. Many of these accessories are cosmetic enhancements, not intended to provide any significant function other than to alter the appearance of the device. However, some accessories are functional in that they allow the device to be used more easily.

One such accessory is the so-called “hands-free kit” which generally allows the user to operate certain functions of the device remotely. Hands-free kits take a number of forms. In the most basic form, the hands-free kit comprises a relatively long cable having an earpiece at one end and an audio adaptor at the other, the former intended for insertion in the ear of the user and the latter being arranged to plug into a corresponding socket on the mobile phone. A microphone is connected to the cable at a position, distanced from the earpiece, where in normal usage it hangs somewhere in the region of the user's mouth. The user is thus able to take part in a telephone-conversation by speaking into the microphone and listening by means of the earpiece without having to manually hold either the microphone or the mobile phone itself—hence the term “hands-free”.

This type of kit is gaining approval by the telecommunications industry since it addresses the recently-expressed concerns that conventional mobile phones, placed near the head during use, are damaging to the health of the user.

However, an area of particular concern to the telecommunications industry and other bodies is in the use of mobile telephones or other devices whilst driving. Clearly, a driver engaged in a telephone conversation whilst holding the device next to his ear is unlikely to be focussing his attention wholly on the road and, in any event, has only one hand available to operate the vehicle controls. Thus, and owing to the number of accidents occurring through drivers' use of mobile phones whilst driving which distracts their attention from the road, there has been a recent drive towards providing methods by which mobile phones can be used safely whilst driving a vehicle.

A second type of hands-free kit, specifically designed for use in automobiles, comprises a cradle which is fixedly mounted to the dashboard of the vehicle and on which the mobile phone can be seated. The cradle is provided with plugs or other connectors which are arranged to engage with corresponding sockets or connectors on the mobile phone when the latter is seated on the cradle. The plugs/connectors provided on the cradle are hard-wired into the audio system of the vehicle such that incoming calls can be heard through the speakers thereof. In most cases, a remote or hard-wired microphone is provided in the vehicle which enables the driver to speak into the phone.

An advantage of such systems is that the driver can use the phone without holding it to his ear and is thus less distracted from the road. A disadvantage of such systems is that they are generally extremely costly, are frequently compatible only with modern (and hence expensive) audio systems and usually require professional installation.

It is an aim of the present invention to provide a more simple and less expensive apparatus for enabling a mobile phone or the like to be used in a “hands-free” manner. It would be advantageous if such apparatus did not require professional installation.

According to one aspect of the present invention, therefore, there is provided an apparatus for connecting a mobile communications device to an audio system, the apparatus comprising connecting means for connection to said device, a cassette-type audio adaptor, a microphone or the like and transmission means for permitting audio signals to be transmitted between said connection device, said cassette-type audio adaptor and/or said microphone.

According to another aspect of the present invention, there is provided an apparatus suitable for connecting a communications device or other audio/audio-visual device to an audio system, the apparatus comprising a cassette-type audio adaptor having receiver means for receiving audio and/or data signals transmitted from said device or the like and connecting means connecting said receiver means to a head of the cassette-type audio adaptor thereby to apply said signals to said head.

The receiver means may comprise part of a Bluetooth chip located within the body of the cassette-type adaptor.

The present invention will now be described, by way of example only, with reference to the accompanying drawings in which:

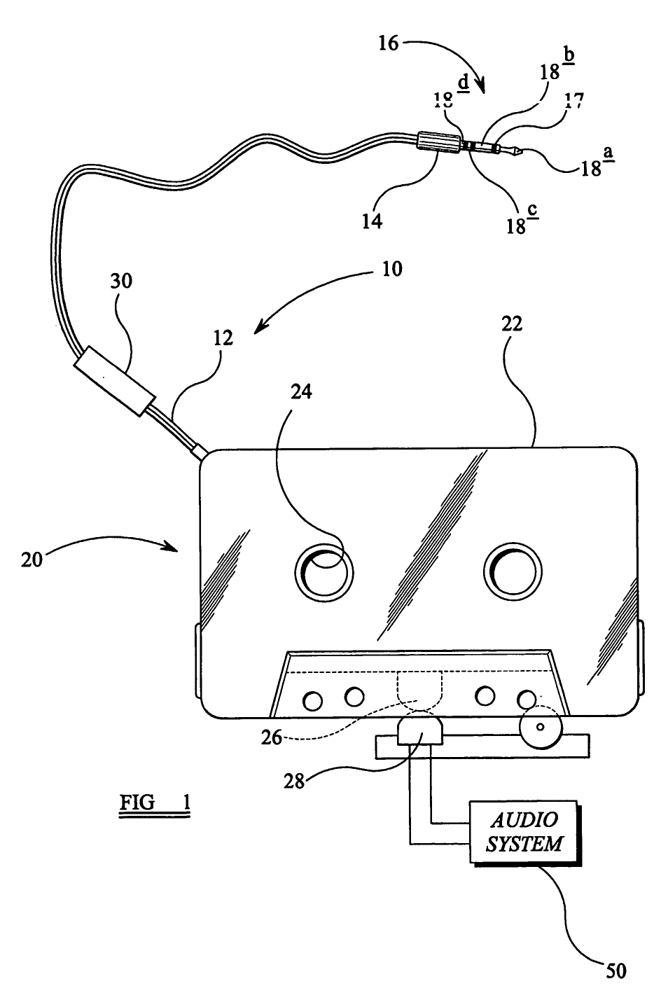

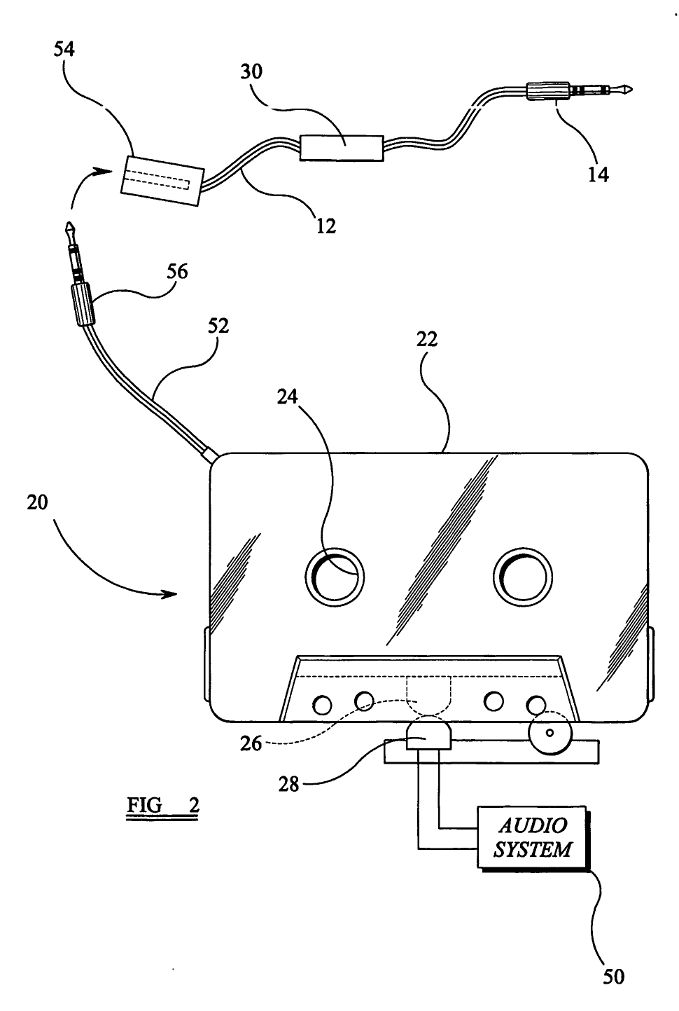

FIG. 1 illustrates a first form of apparatus according to one aspect of the invention;

FIG. 2 illustrates a second form of apparatus according to one aspect of the invention; and

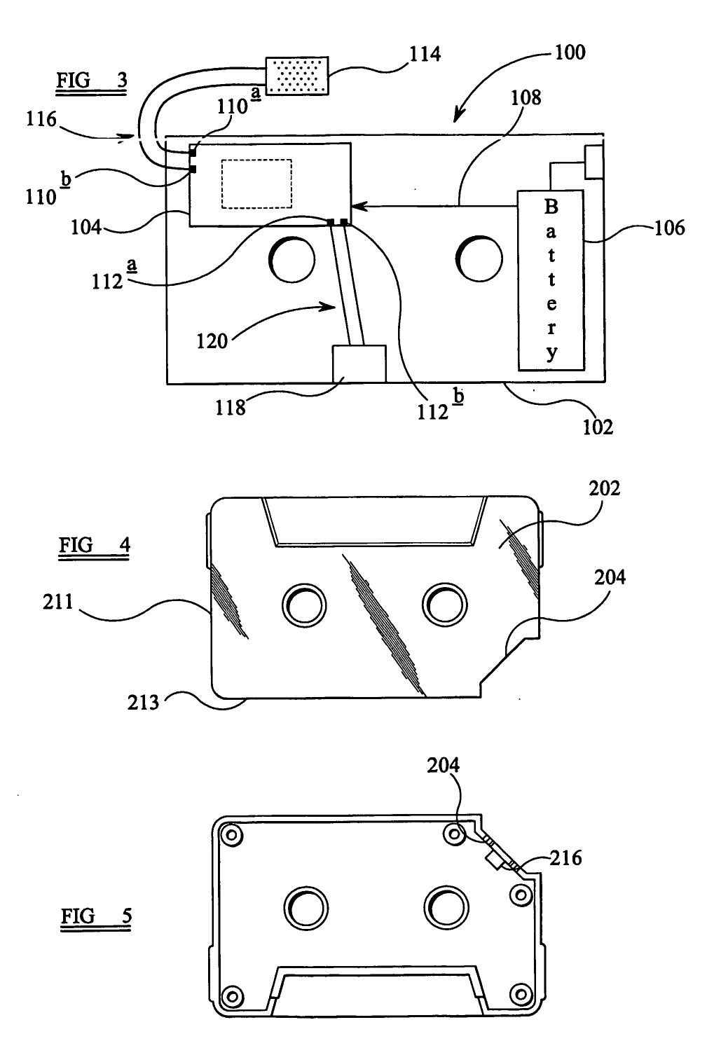

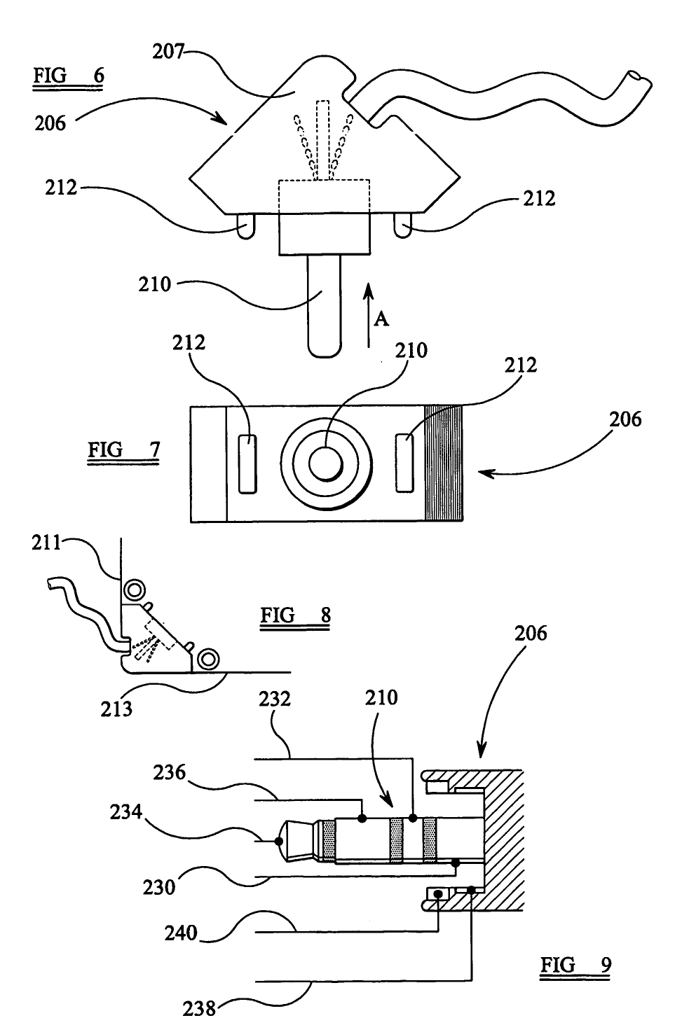

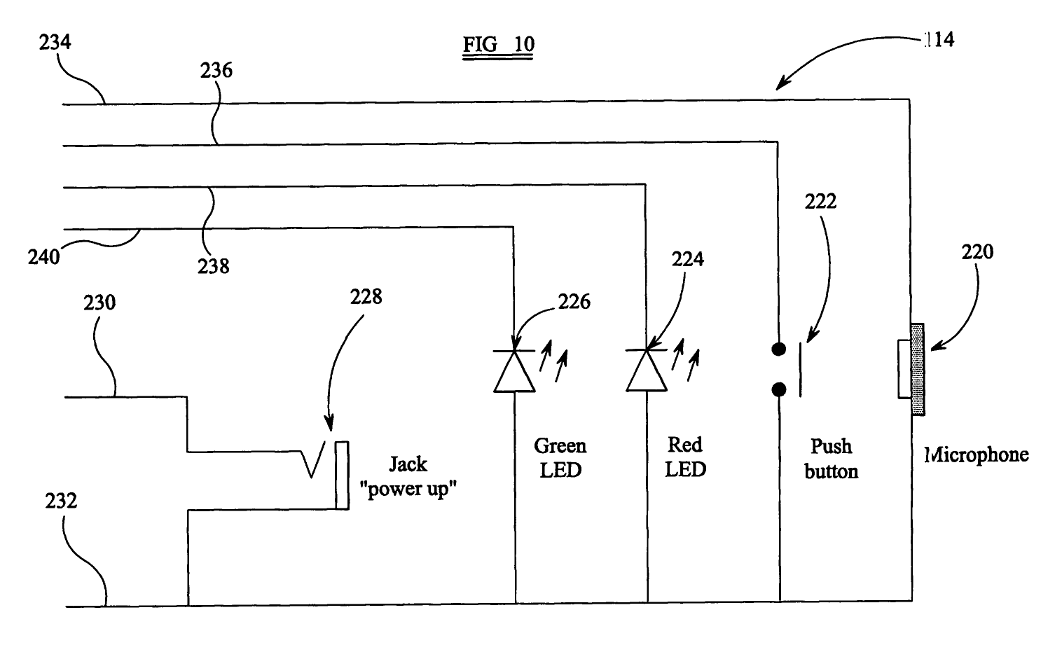

FIG. 3 illustrates schematically a preferred form of apparatus according to a second aspect of the invention.

Referring to FIG. 1, a first form of apparatus according to one aspect of the invention is shown generally at 10. The apparatus 10 comprises a cable 12 having an insulating outer sheath and a plurality of individually insulated core wires (not shown). In this embodiment, the cable 12 includes four such core wires, each individually insulated by a respective inner sheath. The core wires may be shielded either individually or jointly.

One end of the cable 12 is provided with connecting means in the form of a plug or jack 14. In the illustrated embodiment, the jack is a 3½ mm jack of broadly conventional form having a cylindrical male portion 16 which is divided along its axis, by means of insulating spacers 17 into a plurality of conductive regions, each region constituting a respective electrode. In the embodiment shown, the male portion is divided into four electrodes, 18a-18d each electrode being electrically connected in a conventional manner to a respective one of the core wires in the cable 12.

It will be understood that the type of connecting means provided is not essential and will depend upon the sockets or connectors or the communication device to which the apparatus is to be connected. Various convertors or adaptors may be provided to enable connection of the apparatus to several models of communication device.

The end of the cable 12 remote from the jack 14 is connected to an audio adaptor 20 of the type which enables audio signals produced by a portable compact disk player to be reproduced by a conventional cassette deck. Such devices, hereafter referred to as “cassette-type audio adaptors” are readily commercially available and are described in detail in, for example, U.S. Pat. No. 4,734,897, the contents of which are herein incorporated by reference.

For completeness, however, the cassette-type audio adaptor 20 comprises a housing 22 having a configuration substantially identical to the configuration of a cassette normally used with a playback cassette deck. The adaptor housing 22 has at least one opening 24 to receive the usual reel-drive spindle of the cassette deck and a record head 26 is supported in the housing in a position for contacting the usual playback head 28 of the cassette deck when the adaptor is received or loaded into the deck.

When inserted into the cassette deck, electrical audio signals transmitted on the cable 12 are supplied to the record head 26 of the adaptor 20 from which they are coupled to the playback head 28 of the cassette deck for reproduction in the audio system 50.

The apparatus of the invention also includes a microphone 30 which is connected to the cable 12 at a point between the cassette-type audio adaptor 20 and the jack 14.

It will be understood that, of the four core wires in the cable 12, only two may be required to connect the microphone 30 to respective electrodes of the jack 14 whilst the remaining two may be required to connect the record head 26 of the cassette-type adaptor 20 to the remaining two electrodes of the jack 14. It will be further understood, therefore, that the portion of the cable 12 between the microphone 30 and the cassette-type adaptor 20 may include only two core wires, the four-core cable extending only between the jack 14 and the microphone 30. The number of core wires in the cable and there arrangement therein will, however, depend on the use for which the apparatus is intended.

In use, the user connects the mobile phone to the apparatus 10 by means of the jack 14 or other connection means and inserts the cassette-type audio adaptor 20 into the cassette player of an audio system which conveniently may be an audio system of a motor vehicle. When the cassette player is switched on, audio signals generated by the mobile are transmitted electrically along the cable 12 via the relevant core wires and are coupled to the playback head 28 of the cassette deck via the record head 26 of the cassette-type audio adaptor 20. Thus, all audio signals produced by the mobile telephone, including ring tones, voice mail messages or the like, are reproduced by the vehicle audio system.

Depending on its location on the cable 12, the microphone 30 can be positioned anywhere in the vehicle to enable the user to speak into the mobile phone. Audio signals detected by the microphone are transmitted to the mobile telephone via the cable 12 and the jack 14 for transmission by the telephone in the usual manner.

Various modifications and improvements may be made to the invention. For example, the microphone 30 may comprise a remote microphone which is not hard-wired to the jack 14 but which communicates to a receiving device hard-wired to the jack by remote transmission means such as radio, infra-red or the recently-introduced “blue-tooth” technology. This would allow the microphone to be placed at any desired location in the vehicle without the need for routing of wires around the interior of the vehicle. In addition, or alternatively, the telephone or the jack and the cassette-type adaptor may communicate remotely, for example via radio, infra-red or any other suitable link, including “blue-tooth” technology. Where a cable 12 is used between the jack and the cassette-type audio adaptor, or between the jack and the microphone, a coiled flexible cord is considered advantageous for reasons of versatility, space and aesthetics.

An adaptor or converter may be provided to convert the jack 14 to a type suitable for connection to a portable CD player or the like. Further core wires may be required for this purpose. Clearly, when used in a motor vehicle, an optional cradle or holder maybe provided for the mobile phone to permit easy access thereto.

In an alternative embodiment shown in FIG. 2, the cable 12 is not connected directly to a cassette-type audio adaptor but instead has a socket 54 for connection to the jack 56 of a “conventional” cassette-type audio adaptor (i.e. one arranged for connection to a portable CD player or the like). This embodiment allows users with existing cassette-type audio adaptors to use these adaptors with their mobile phone.

Referring now to FIG. 3, this illustrates schematically a preferred form of apparatus according to a second aspect of the invention. In this embodiment, the apparatus makes use of so-called “Bluetooth” technology, as mentioned above.

Bluetooth is the name given to a form of wireless technology which permits electronic communications devices, such as mobile telephones and radios, to communicate with a user or other Bluetooth-enabled device without the need for connecting wires. A Bluetooth chip replaces the cable normally connecting two devices, such as a mobile telephone and a conventional hands-free earpiece or headset, by transmitting the audio or data information generated by a first one of the devices at a specific 2.4 GHz frequency to a similar chip in the second of the devices.

The Bluetooth wireless specification, unlike many other wireless standards, includes both link layer and application layer definitions for product developers which supports data and voice applications. Bluetooth chips operate in the unlicensed 2.4 GHz radio spectrum ensuring communication compatibility worldwide. The technology uses a frequency hopping spread spectrum (FHSS), full duplex signal at up to 1600 hops/sec. The signal hops between seventy nine frequencies at 1 MHz intervals to give a high degree of interference immunity. Up to seven simultaneous connections can be established and maintained.

The apparatus of FIG. 3 comprises a cassette-type adaptor 102 of the kind described with reference to FIGS. 1 and 2. In this embodiment, the cassette-type adaptor 102 includes processor means in the form of a Bluetooth chipset shown representatively at 104. The Bluetooth chipset may be a conventional Bluetooth chip, such as is provided in a Bluetooth enabled mobile telephone, earpiece or headset. Such known chips will be sell understood by those skilled in the art and a detailed description thereof will not be made. Only those features of the chip which are important (but not necessarily essential) for the operation of the chip in apparatus of the present invention, or for the understanding thereof, will be made herein.

The chip 104 is located within the body of the cassette-type adaptor 102 and is connected to a battery or power cell 106 by means of a power cable 108. The power cable provides electrical energy from the cell 106 to the power input of the chip in order to power the electronic components of the chip. The cell 106 is connected to a charging port located on the outer surface of the cassette-type adaptor 102 to enable the cell to be charged by any suitable means.

The Bluetooth chip 104 has two inputs 110a, 110b and two outputs 112a, 112b. The inputs 110a, 110b are connected to the electrical outputs of a microphone 114, by means of a microphone cable 116 having two core wires, in a manner similar to that described with reference to FIG. 1. It will be appreciated that one of the inputs 110a, 110b may represent a ground input whilst the other may represent a signal input.

The outputs 112a, 112b of the Bluetooth chip 104 are connected to the record head 118 by means of a record cable 120 having two core wires. In practice, the record head 118 of the cassette-type adaptor may be capable of transmitting stereo signals to the cassette player and may therefore have three electrodes (left signal, right signal and ground) to which the wires of the record cable 120 can be connected. At present, Bluetooth chips are capable of communicating monophonically only. Thus, the left and right signal electrodes of the record head 118 are connected together electrically, for example by a solder link or the like, and the corresponding core wire of the record cable 120 is connected thereto. The other core wire of the record cable 120 is connected to the ground electrode of the record head 118. In use, this arrangement will ensure that the monophonic signal applied to the record head will be received by both pickups of the cassette player's playback head such that the audio signals will be applied to both the left and right speakers of the audio system giving a quasi-stereo effect.

It is, however, envisaged that Bluetooth chips will eventually be capable of transmitting and receiving stereo signals. To allow for this, the chip will have three or more outputs, for example left signal, right signal and ground. In such an embodiment, the left signal output of the chip will be connected to the left signal electrode of the cassette-type adaptor, the right signal output of the chip will be connected to the right signal electrode of the cassette-type adaptor and the ground output of the chip will be connected to the ground electrode of the cassette-type adaptor.

The inputs 110a, 110b are connected to transmission means in the form of a transmitter IC (not shown). The transmitter IC is arranged to receive the audio signals from the microphone 114 on the microphone cable 116 and to transmit these to the mobile communications device using the FHSS technique described above.

On the other hand, the outputs 112a, 112b are connected to receiver means in the form of a receiver IC (not shown). The receiver IC is arranged to receive information signals transmitted by the communications device and to-convert these into audio signals and apply them to the outputs 112a, 112b, whence they are applied to the record head 118 of the cassette-type adaptor 102 via the record cable 120.

In use, therefore, the cassette-type adaptor is inserted into the cassette player of the audio system as described above with the microphone located at the end of the microphone cable protruding from the cassette player. The mobile telephone can be located at any desired position which can be some distance from the cassette player. For example, when used in a car or other vehicle, the apparatus can still be used effectively even if the mobile telephone is in the boot of the vehicle.

When an incoming call is received by the mobile telephone, a ring signal is transmitted by the Bluetooth chip provided in the telephone. This signal is received by the chip 104 in the cassette-type adaptor 102 which converts the signal into an audio signal which is applied to the record head for playback by the cassette player. Thus, the ringing tone is heard through the speakers of the audio system.

During the call, audio signals from the user (e.g. the driver of the vehicle) are picked up by the microphone 114 and applied via the microphone cable 116 and inputs 110a, 110b to the transmitter IC in the Bluetooth chip 104. The transmitter IC converts the audio signals into digital signals and transmits them using the FHSS technique described above to the mobile telephone. These digital signals are received by the Bluetooth chip in the mobile telephone which then transmits them via the telephone network in the conventional manner.

Incoming signals from the telephone network are received by the mobile telephone and retransmitted by the Bluetooth chip of the device. These signals are received by the receiver IC of the Bluetooth chip 104 in the cassette type adaptor which converts them into audio signals and applies them, via outputs 112a, 112b and the record cable 120, to the record head 118 of the cassette-type adaptor for playback via the audio system. All incoming audio signals are therefore heard through the speakers of the audio system.

Various modifications and improvements can also be made to this embodiment. For example, the apparatus may include means, such as one or more buttons or a keypad, for controlling the mobile telephone. The buttons/keypad could be connected to the cassette-type adaptor 102 in a manner similar to the microphone 114 and used for one or more commands such as dial out, receive, number selection etc. All such commands are transmitted to the mobile telephone by the Bluetooth chip 104.

In addition, or alternatively, the apparatus could incorporate voice activation facilities. For example, the user could, by speaking into the microphone, control various functions of the mobile telephone such as dial out, receive, number selection etc. Again, all such commands are transmitted to the mobile telephone by the Bluetooth chip 104. In a further modification, the microphone may itself be Bluetooth enabled, i.e. it has its own Bluetooth chip. In this embodiment, the microphone need not be connected to the cassette type adaptor by a cable but can be fully wireless. To simplify construction, the Bluetooth chip in the microphone need only have a transmitter IC (no receiver IC is required) whilst the Bluetooth chip in the cassette type adaptor need only have a receiver IC (no transmitter IC is required).

An advantageous modification permits the rotating drive mechanisms of the cassette player to be used to charge the battery 106. Here, the cassette-type adaptor 102 includes a generator, dynamo or the like which is connected to the spools of the adaptor. As the spools are driven by the cassette player, the dynamos are rotated thereby to generate an electrical current for charging the battery. In addition, or alternatively, the cassette-type adaptor maybe provided with solar cells or the like which allow the battery to be charged and/or the Bluetooth chip to be powered by solar energy.

Since the apparatus is self-sufficient, it does not require to be used in conjunction with an audio system. For example, the cassette-type adaptor may be provided with an audio socket for the connection of a conventional handsfree microphone/earpiece unit, such as described herein in the third paragraph of page 1. This allows the apparatus to be used without a stereo system—the cassette type adaptor can be carried in a shirt pocket or the like whilst allowing communication with the mobile telephone which may be carried in a bag or briefcase etc.

It is also envisaged that other accessories/products may be possible. For example, Bluetooth compatible glasses or sunglasses may be desirable. The arms of the glasses could house the earpiece and a microphone extension as well as the Bluetooth chip. Tie pins could also be used.

The Bluetooth chip may be any suitable chip or module, such as a headset or handsfree module, for example a Cambridge Silicon Radio chipset, an Ericsson chipset or a Texas chipset. In addition, the apparatus is not limited to use with a mobile telephone. Any Bluetooth-enabled device may be suitable for use with the apparatus. While a hands-free kit for mobile telephone use is seen as the most advantageous application, particularly for use in cars or other vehicles, other applications may include audio-visual applications such as televisions or home entertainment systems, portable audio devices such as cd players, minidisc players or MP3 players or even Bluetooth enabled toys or the like.

The apparatus permits audio signals generated by an electronic device of any kind, provided it is Bluetooth compatible, to be played and heard through an existing audio system without the need for connecting cables and wires. In some applications, in particular those where two-way communication is not required (for example for audio players such as cd players, minidisc players, MP3 players or the like), the apparatus does not need a transmitter IC since all signals are transmitted by the audio player and received by the apparatus. Where two-way communication is required, the Bluetooth chip should have both a transmitter IC and a receiver IC.

The apparatus 100 is capable of handling monophonic or stereophonic signals and means, such as a switch, may be provided on the apparatus itself for switching between monophonic and stereophonic operation.

It will be appreciated that the present invention provides an exceptionally simple apparatus which can be used as an effective and inexpensive hands-free kit for a mobile phone or the like. No professional installation of the apparatus is required in the vehicle and thus the apparatus is significantly less expensive than existing hands-free kits. In addition, unlike existing hard-wired hands-free kits, the present invention is wholly portable and can be easily removed from the vehicle to deter theft.

1. An apparatus suitable for connecting a communications device or other audio/audio-visual device to an audio system, the apparatus comprising a cassette-type audio adaptor having receiver means for receiving audio and/or data signals transmitted from said device or the like and connecting means connecting said receiver means to a head of the cassette-type audio adaptor thereby to apply said signals to said head.

2. An apparatus according to claim 1 wherein said receiver means comprises at least a part of a Bluetooth chipset disposed within the cassette-type adaptor.

3. An apparatus according to claim 2 wherein said Bluetooth chipset includes transmission means for transmitting audio signals back to said device as electromagnetic signals.

4. An apparatus according to claim 2 further comprising a microphone connected to said transmission means for detecting audio signals from a user and applying them to said transmission means.

5. An apparatus for connecting a communications device to an audio system, the apparatus comprising:
a cassette-type adaptor:
a microphone;
a Bluetooth chipset or the like disposed within said cassette type adaptor, the Bluetooth chipset or the like comprising:
transmitter means for transmitting audio signals received by the microphone and/or data signals to the communications device; and
receiver means for receiving audio and/or data signals transmitted from said communications device;
and means for applying said received signals to a record head of the cassette-type adaptor.

6. An apparatus for connecting a communications device to an audio system, the apparatus comprising connecting means for connection to said device, a cassette-type audio adaptor, a microphone or the like and transmission means for permitting audio signals to be transmitted between said connection device, said cassette-type audio adaptor and/or said microphone.

7. An apparatus according to claim 6 wherein said transmission means comprises a cable connected between said connection means and either said microphone, said cassette-type audio adaptor or both.

8. An apparatus according to claim 6 wherein said transmission means comprises one or more transmitters for transmitting audio signals as electromagnetic signals between said connection means and either said microphone, said cassette-type audio adaptor or both.

9. An apparatus as claimed in any of claims 6 to 8 wherein said connecting means comprises a jack or other connector arranged to plug into or connect with corresponding socket or connector on said communications device.
